(19) United States
(12) Patent Application Publication
(10) Pub. No.: US 2022/0081624 A1
(43) Pub. Date: Mar. 17, 2022

(54) METHODS FOR UPGRADING HYDROCARBON FEEDS TO PRODUCE OLEFINS

(71) Applicant: Saudi Arabian Oil Company, Dhahran (SA)

(72) Inventors: Aaron Chi Akah, Dhahran (SA); Abdennour Bourane, Dhahran (SA); Musaed Salem Al-Ghrami, Dhahran (SA)

(73) Assignee: Saudi Arabian Oil Company, Dhahran (SA)

(21) Appl. No.: 17/019,765

(22) Filed: Sep. 14, 2020

(51) Int. Cl. C10G 11/05; C10G 11/18; C10G 55/06

(52) U.S. Cl. CPC C10G 11/05; B01J 29/40; C10G 55/06; C10G 11/182

(57) ABSTRACT

The present disclosure is directed to methods for upgrading a hydrocarbon feed that may include separating the hydrocarbon feed to produce at least a greater boiling point effluent and a lesser boiling point effluent. The greater boiling point effluent may have an American Petroleum Institute gravity less than 30 degrees. The method may further include contacting the greater boiling point effluent with a multicomponent catalyst, which may cause at least a portion of the greater boiling point effluent to undergo catalytic cracking and produce a first spent multicomponent catalyst and a first cracked effluent comprising one or more olefins. The multicomponent catalyst may include from 0 weight percent to 10 weight percent ZSM-5, from 10 weight percent to 40 weight percent zeolite Beta, and from 10 weight percent to 30 weight percent USY zeolite based on the total weight of the multicomponent catalyst.

### BACKGROUND

### Field

The present disclosure relates to systems and methods for processing petroleum-based materials and, in particular, systems and methods for upgrading hydrocarbon feeds to produce olefins.

### Technical Background

The worldwide increasing demand for light olefins remains a major challenge for many integrated refineries. In particular, the production of some valuable light olefins, such as ethylene and propylene, has attracted increased attention as pure olefin streams are considered the building blocks for polymer synthesis. The production of light olefins depends on several process variables, such as the feed type, operating conditions, and the type of catalyst. Despite the options available for producing a greater yield of propylene and light olefins, intense research activity in this field is still being conducted. For example, light olefins are typically produced through thermal cracking (or steam pyrolysis) of petroleum gases and distillates, such as naphtha, kerosene, or gas oil. Light olefins may also be produced through fluid catalytic cracking processes. Typical hydrocarbon feeds for fluid catalytic cracking processes range from hydrocracked bottoms to heavy feed fractions such as vacuum gas oil and atmospheric residue; however, these hydrocarbon feeds are limited, at least in part, due to limitations of conventional catalysts used in fluid catalytic cracking processes.

### SUMMARY

Accordingly, there is an ongoing need for systems and methods for upgrading hydrocarbon feeds to produce olefins with a greater selectivity and yield of light olefins from a greater variety of hydrocarbon feeds compared to conventional systems and methods for upgrading hydrocarbon feeds. The systems and methods of the present disclosure include the processing of a hydrocarbon feed in two fluid catalytic cracking units arranged in parallel with a multicomponent catalyst. In particular, the systems and methods of the present disclosure include contacting the hydrocarbon feed with a multicomponent catalyst that comprises two or more different zeolitic components. The inclusion of these different zeolitic components may allow for increase the selectivity and yield of light olefins across the entire range of some unconventional hydrocarbon feeds for fluid catalytic cracking processes, such as crude oil.

According to at least one aspect of the present disclosure, a method for upgrading a hydrocarbon feed may include introducing the hydrocarbon feed to a separation unit. The separation unit may separate the hydrocarbon feed to produce at least a greater boiling point effluent and a lesser boiling point effluent. The greater boiling point effluent may have an American Petroleum Institute gravity less than 30 degrees. The method may further include passing the greater boiling point effluent to a first downflow fluid catalytic cracking unit downstream of the separation unit. The first downflow fluid catalytic cracking unit may contact the greater boiling point effluent with a multicomponent catalyst, which may cause at least a portion of the greater boiling point effluent to undergo catalytic cracking and produce a first spent multicomponent catalyst and a first cracked effluent comprising one or more olefins. The multicomponent catalyst may include from 0 weight percent to 10 weight percent ZSM-5, from 10 weight percent to 40 weight percent zeolite Beta, and from 10 weight percent to 30 weight percent USY zeolite based on the total weight of the multicomponent catalyst.

According to another aspect of the present disclosure, a method for upgrading a hydrocarbon feed may include separating the hydrocarbon feed to produce at least a greater boiling point effluent and a lesser boiling point effluent. The greater boiling point effluent may have an American Petroleum Institute gravity less than 30 degrees. The method may further include contacting the greater boiling point effluent with a multicomponent catalyst, which may cause at least a portion of the greater boiling point effluent to undergo catalytic cracking and produce a first spent multicomponent catalyst and a first cracked effluent comprising one or more olefins. The multicomponent catalyst may include from 0 weight percent to 10 weight percent ZSM-5, from 10 weight percent to 40 weight percent zeolite Beta, and from 10 weight percent to 30 weight percent USY zeolite based on the total weight of the multicomponent catalyst.

Additional features and advantages of the aspects of the present disclosure will be set forth in the detailed description that follows and, in part, will be readily apparent to a person of ordinary skill in the art from the detailed description or recognized by practicing the aspects of the present disclosure.

### BRIEF DESCRIPTION OF THE DRAWINGS

The following detailed description of the present disclosure may be better understood when read in conjunction with the following drawings in which:

FIG. 1 schematically depicts a generalized flow diagram of a system for upgrading a hydrocarbon feed to produce olefins, according to one or more aspects of the present disclosure; and

FIG. 2 schematically depicts a portion of the system schematically depicted in FIG. 1, according to one or more aspects of the present disclosure.

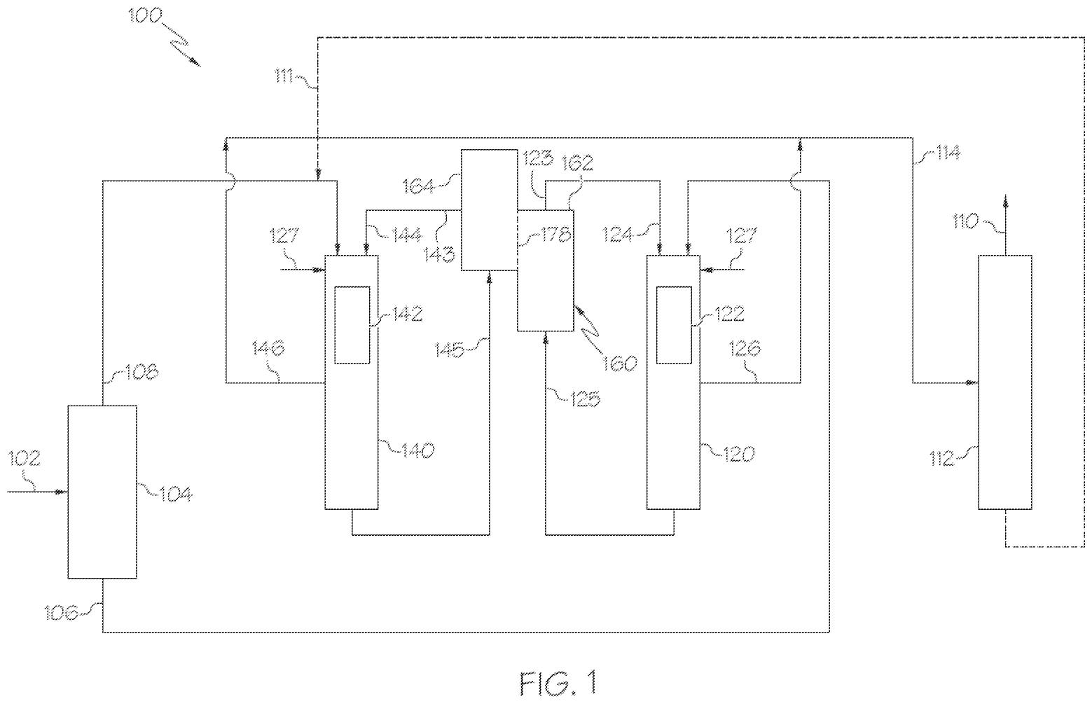

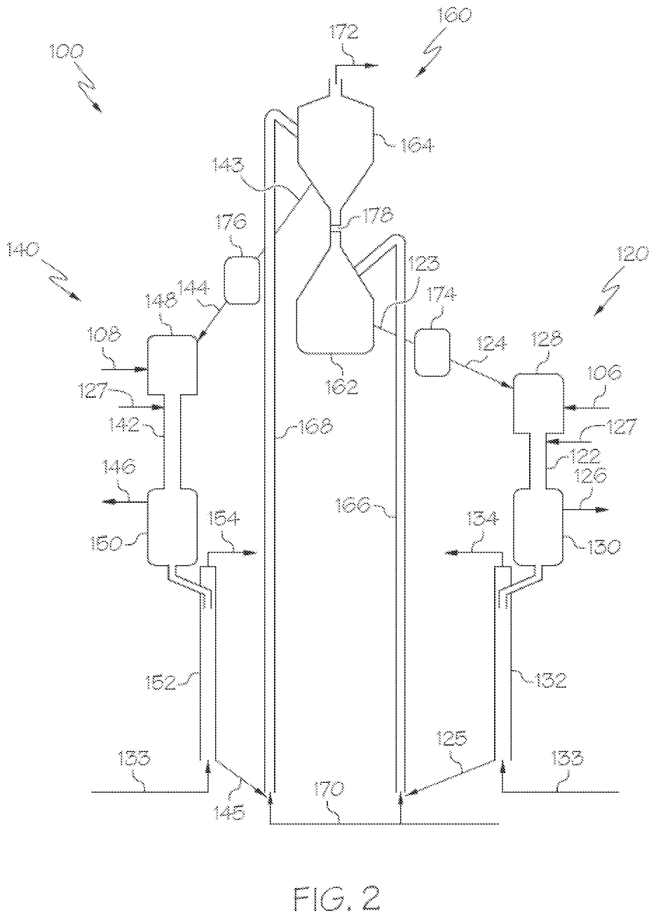

When describing the simplified schematic illustration of FIGS. 1 and 2, the numerous valves, temperature sensors, electronic controllers, and the like, which may be used and are well known to a person of ordinary skill in the art, are not included. Further, accompanying components that are often included in systems such as those depicted in FIGS. 1 and 2, such as air supplies, heat exchangers, surge tanks, and the like are also not included. However, a person of ordinary skill in the art understands that these components are within the scope of the present disclosure.

Additionally, the arrows in the simplified schematic illustration of FIGS. 1 and 2 refer to process streams. However, the arrows may equivalently refer to transfer lines, which may transfer process steams between two or more system components. Arrows that connect to one or more system components signify inlets or outlets in the given system components and arrows that connect to only one system component signify a system outlet stream that exits the depicted system or a system inlet stream that enters the depicted system. The arrow direction generally corresponds with the major direction of movement of the process stream or the process stream contained within the physical transfer line signified by the arrow.

The arrows in the simplified schematic illustration of FIGS. 1 and 2 may also refer to process steps of transporting a process stream from one system component to another system component. For example, an arrow from a first system component pointing to a second system component may signify “passing” a process stream from the first system component to the second system component, which may comprise the process stream “exiting” or being “removed” from the first system component and “introducing” the process stream to the second system component.

Reference will now be made in greater detail to various aspects, some of which are illustrated in the accompanying drawings.

### DETAILED DESCRIPTION

The present disclosure is directed to systems and methods for upgrading hydrocarbon feeds to produce olefins. Referring to FIG. 1, a system 100 of the present disclosure for processing a hydrocarbon feed 102 to produce olefins is schematically depicted. The system 100 may comprise a separation unit 104, a first fluid catalytic cracking unit 120 downstream of the separation unit 104, and a second fluid catalytic cracking unit 140 downstream of the separation unit 104 and parallel to the first fluid catalytic cracking unit 120. The separation unit 104 may separate the hydrocarbon feed 102 to produce at least a greater boiling point effluent 106 and a lesser boiling point effluent 108. The first fluid catalytic cracking unit 120 and the second fluid catalytic cracking unit 140 may contact the greater boiling point effluent 106 and the lesser boiling point effluent 108, respectively, with a multicomponent catalyst. The multicomponent catalyst may include a first large pore molecular sieve, such as zeolite Beta, a second large pore molecular sieve, such as ultrastable Y (USY) zeolite, and, optionally, a shape selective cracking catalyst, such as Zeolite Socony Mobil-5 (ZSM-5). The contact of the greater boiling point effluent 106 and the lesser boiling point effluent 108 with the multicomponent catalyst may cause at least a portion of the greater boiling point effluent 106 and the lesser boiling point effluent 106 to undergo catalytic cracking and produce effluents comprising one or more olefins. Without being bound by any particular theory, it is believed that the multicomponent catalyst may be active enough to promote the catalytic cracking of lighter hydrocarbons, such as those present in the lesser boiling point effluent 108, and mild enough to avoid the excessive catalytic cracking of heavier hydrocarbons, such as those present in the greater boiling point effluent 106. This balanced activity provided by the mixture of components of the multicomponent may increase the yield of products, such as light olefins, from the catalytic cracking of both light hydrocarbons and heavy hydrocarbons.

As used in the present disclosure, the indefinite articles “a” and “an,” when referring to elements of the present disclosure, mean that least one of these elements are present. Although these indefinite articles are conventionally employed to signify that the modified noun is a singular noun, the indefinite articles “a” and “an” also include the plural in the present disclosure, unless stated otherwise. Similarly, the definite article “the” also signifies that the modified noun may be singular or plural in the present disclosure, unless stated otherwise.

As used in the present disclosure, the term “or” is inclusive and, in particular, the term “A or B” refers to “A, B, or both A and B.” Alternatively, the term “or” may be used in the exclusive sense only when explicitly designated in the present disclosure, such as by the terms “either A or B” or “one of A or B.”

As used in the present disclosure, the term “cracking” refers to chemical reaction where a molecule having carbon-carbon bonds is broken into more than one molecule by the breaking of one or more of the carbon-carbon bonds; where a compound including a cyclic moiety, such as an aromatic, is converted to a compound that does not include a cyclic moiety; or where a molecule having carbon-carbon double bonds are reduced to carbon-carbon single bonds. As used in the present disclosure, the term “catalytic cracking” refers to cracking conducted in the presence of a catalyst. Some catalysts may have multiple forms of catalytic activity, and calling a catalyst by one particular function does not render that catalyst incapable of being catalytically active for other functionality.

As used in the present disclosure, the term “catalyst” refers to any substance which increases the rate of a specific chemical reaction, such as cracking reactions.

As used in the present disclosure, the term “spent catalyst” refers to catalyst that has been contacted with reactants at reaction conditions, but has not been regenerated in a regenerator. The “spent catalyst” may have coke deposited on the catalyst and may include partially coked catalyst as well as fully coked catalysts. The amount of coke deposited on the “spent catalyst” may be greater than the amount of coke remaining on the regenerated catalyst following regeneration. The “spent catalyst” may also include catalyst that has a reduced temperature due to contact with the reactants compared to the catalyst prior to contact with the reactants.

As used in the present disclosure, the term “regenerated catalyst” refers to catalyst that has been contacted with reactants at reaction conditions and then regenerated in a regenerator to heat the catalyst to a greater temperature, oxidize and remove at least a portion of the coke from the catalyst to restore at least a portion of the catalytic activity of the catalyst, or both. The “regenerated catalyst” may have less coke, a greater temperature, or both, compared to spent catalyst and may have greater catalytic activity compared to spent catalyst. The “regenerated catalyst” may have more coke and lesser catalytic activity compared to fresh catalyst that has not passed through a cracking reaction zone and regenerator.

As used in the present disclosure, the term “crude oil” refers to a mixture of petroleum liquids and gases, including impurities, such as sulfur-containing compounds, nitrogen-containing compounds, and metal compounds, extracted directly from a subterranean formation or received from a desalting unit without having any fractions, such as naphtha, separated by distillation.

As used in the present disclosure, the term “naphtha” refers to an intermediate mixture of hydrocarbon-containing materials derived from crude oil refining and having atmospheric boiling points from 36 degrees Celsius (° C.) to 220° C. Naphtha may comprise light naphtha comprising hydrocarbon-containing materials having atmospheric boiling points from 36° C. to 80° C., intermediate naphtha comprising hydrocarbon-containing materials having atmospheric boiling points from 80° C. to 140° C., and heavy naphtha comprising hydrocarbon-containing materials having atmospheric boiling points from 140° C. to 200° C. Naphtha may comprise paraffinic, naphthenic, and aromatic hydrocarbons having from 4 carbon atoms to 11 carbon atoms.

As used in the present disclosure, the term “directly” refers to the passing of materials, such as an effluent, from a first component of the system 100 to a second component of the system 100 without passing the materials through any intervening components or systems operable to change the composition of the materials. Similarly, the term “directly” also refers to the introducing of materials, such as a feed, to a component of the system 100 without passing the materials through any preliminary components operable to change the composition of the materials. Intervening or preliminary components or systems operable to change the composition of the materials may comprise reactors and separators, but are not generally intended to include heat exchangers, valves, pumps, sensors, or other ancillary components required for operation of a chemical process.

As used in the present disclosure, the terms “downstream” and “upstream” refer to the positioning of components or systems of the system 100 relative to a direction of flow of materials through the system 100. For example, a second system may be considered “downstream” of a first system if materials flowing through the system 100 encounter the first system before encountering the second system. Likewise, the first system may be considered “upstream” of the second system if the materials flowing through the system 100 encounter the first system before encountering the second system.

As used in the present disclosure, the term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed. For example, a slipstream may carry some of the effluent away, meaning that only a portion of the effluent may enter the downstream component or system. The terms “reaction effluent” and “reactor effluent” may be used to particularly refer to a stream that is passed out of a reactor or reaction zone.

As used in the present disclosure, the term “high-severity conditions” refers to operating conditions of a fluid catalytic cracking system, such as the fluid catalytic cracking system 400, that include temperatures greater than or equal to 580° C., or from 580° C. to 750° C., a catalyst to oil ratio greater than or equal to 1, or from 1 to 60, and a residence time of less than or equal to 60 seconds, or from 0.1 seconds to 60 seconds, each of which conditions may be more severe than typical operating conditions of a fluid catalytic cracking system.

As used in the present disclosure, the term “catalyst to oil ratio” refers to the weight ratio of a catalyst, such as the multicomponent catalyst of the system 100, to a process stream, such as the greater boiling point effluent 106 or the lesser boiling point effluent 108 of the system 100.

The term “residence time” (sometimes also referred to as “time on stream”) refers to the amount of time that reactants, such as the hydrocarbons in the greater boiling point effluent 106 of the system 100, are in contact with a catalyst, at reaction conditions, such as at the reaction temperature.

As used in the present disclosure, the term “reactor” refers to any vessel, container, or the like, in which catalytic cracking may occur between one or more reactants optionally in the presence of one or more fluidized catalysts. For example, fluid catalytic cracking reactors may comprise fluidized bed reactors, such as downflow reactors, upflow reactors or combinations of these. One or more “reaction zones” may be disposed within a reactor. The term “reaction zone” refers to an area where a particular reaction takes place in a reactor.

As used in the present disclosure, the terms “separation unit” and “separator” refer to any separation device(s) that at least partially separates one or more chemical constituents in a mixture from one another. For example, a separation system may selectively separate different chemical constituents from one another, forming one or more chemical fractions. Examples of separation systems include, without limitation, distillation columns, fractionators, flash drums, knock-out drums, knock-out pots, centrifuges, filtration devices, traps, scrubbers, expansion devices, membranes, solvent extraction devices, high-pressure separators, low-pressure separators, or combinations or these. The separation processes described in the present disclosure may not completely separate all of one chemical constituent from all of another chemical constituent. Instead, the separation processes described in the present disclosure “at least partially” separate different chemical constituents from one another and, even if not explicitly stated, separation may include only partial separation.

It should further be understood that streams may be named for the components of the stream, and the component for which the stream is named may be the major component of the stream (such as comprising from 50 wt. %, from 70 wt. %, from 90 wt. %, from 95 wt. %, from 99 wt. %, from 99.5 wt. %, or from 99.9 wt. % of the contents of the stream to 100 wt. % of the contents of the stream). It should also be understood that components of a stream are disclosed as passing from one system component to another when a stream comprising that component is disclosed as passing from that system component to another. For example, a disclosed “hydrogen stream” passing to a first system component or from a first system component to a second system component should be understood to equivalently disclose “hydrogen” passing to the first system component or passing from a first system component to a second system component.

Referring again to FIG. 1, the system 100 of the present disclosure for processing a hydrocarbon feed 102 to produce olefins is schematically depicted. The system 100 may comprise a separation unit 104, a first fluid catalytic cracking unit 120 downstream of the separation unit 104, and a second fluid catalytic cracking unit 140 downstream of the separation unit 104 and parallel to the first fluid catalytic cracking unit 120. The separation unit 104 may separate the hydrocarbon feed 102 to produce at least a greater boiling point effluent 106 and a lesser boiling point effluent 108. The first fluid catalytic cracking unit 120 and the second fluid catalytic cracking unit 140 may contact the greater boiling point effluent 106 and the lesser boiling point effluent 108, respectively, with a multicomponent catalyst. The multicomponent catalyst may include a first large pore molecular sieve, such as zeolite Beta, a second large pore molecular sieve, such as USY zeolite, and, optionally, a shape selective cracking catalyst, such as ZSM-5. The contact of the greater boiling point effluent 106 and the lesser boiling point effluent 108 with the multicomponent catalyst may cause at least a portion of the greater boiling point effluent 106 and the lesser boiling point effluent 106 to undergo catalytic cracking and produce effluents comprising one or more olefins.

The hydrocarbon feed 102 generally comprises one or more hydrocarbon-containing materials. In embodiments, the hydrocarbon feed 102 may be a crude oil. While the present disclosure may specify the hydrocarbon feed 102 as a crude oil, it should be understood that the system 100 of the present disclosure may be applicable for the conversion of a wide variety of hydrocarbon-containing materials, such as, but not limited to, crude oil, vacuum residue, tar sands, bitumen, atmospheric residue, vacuum gas oils, demetalized oils, naphtha streams, or combinations of these. The hydrocarbon feed 102 may further comprise one or more non-hydrocarbon constituents, such as heavy metals, sulfur compounds, nitrogen compounds, inorganic components, or combinations of these. In embodiments where the hydrocarbon feed 102 is crude oil, the hydrocarbon feed 102 may have an American Petroleum Institute (API) gravity of from 22 degrees (°) to 40°. For example, the hydrocarbon feed 102 may be an Arab Extra Light (AXL) crude oil. An example boiling point distribution for an exemplary grade of Arab Extra Light (AXL) crude oil are reported in Table 1.

TABLE 1

| Property | Units | Value | Test Method |
|---|---|---|---|
| 0.1% Boiling Point (BP) | ° C. | 21 | ASTM D3710 |
| 5% BP | ° C. | 65 | ASTM D3710 |
| 10% BP | ° C. | 96 | ASTM D3710 |
| 15% BP | ° C. | 117 | ASTM D3710 |
| 20% BP | ° C. | 141 | ASTM D3710 |
| 25% BP | ° C. | 159 | ASTM D3710 |
| 30% BP | ° C. | 175 | ASTM D3710 |
| 35% BP | ° C. | 196 | ASTM D3710 |
| 40% BP | ° C. | 216 | ASTM D3710 |
| 45% BP | ° C. | 239 | ASTM D3710 |
| 50% BP | ° C. | 263 | ASTM D3710 |
| 55% BP | ° C. | 285 | ASTM D3710 |
| 60% BP | ° C. | 308 | ASTM D3710 |
| 65% BP | ° C. | 331 | ASTM D3710 |
| 70% BP | ° C. | 357 | ASTM D3710 |
| 75% BP | ° C. | 384 | ASTM D3710 |
| 80% BP | ° C. | 415 | ASTM D3710 |
| 85% BP | ° C. | 447 | ASTM D3710 |
| 90% BP | ° C. | 486 | ASTM D3710 |
| 95% BP | ° C. | 537 | ASTM D3710 |
| 100% BP | ° C. | 618 | ASTM D3710 |

One or more supplemental feeds (not depicted) may be mixed with the hydrocarbon feed 102 prior to introducing the hydrocarbon feed 102 to the separation unit 104 or introduced independently to the separation unit 104 in addition to the hydrocarbon feed 102. For example, the hydrocarbon feed 102 may be a crude oil and one or more supplemental streams, such as vacuum residue, atmospheric residue, vacuum gas oils, demetalized oils, naphtha streams, or combinations of these, may be mixed with the hydrocarbon feed 102 upstream of the separation unit 104 or introduced independently to the separation unit 104.

The hydrocarbon feed 102 may be introduced to the separation unit 104, which separates the hydrocarbon feed 102 to produce a plurality of separated effluents that comprise at least a greater boiling point effluent 106 and a lesser boiling point effluent 108. In embodiments, the separation unit 104 may be a vapor-liquid separator, such as a flash drum (sometimes referred to as a breakpot, knock-out drum, knock-out pot, compressor suction drum, or compressor inlet drum), a high-pressure separator, a distillation unit, a fractional distillation unit, a condensing unit, a stripper, a quench unit, a debutanizer, a de-propanizer, a de-ethanizer, or combinations of these. In embodiments where the separation unit 104 is a vapor-liquid separator, the lesser boiling point effluent 108 may exit the separation unit 104 as a vapor and the greater boiling point effluent 106 may exit the separation unit 104 as a liquid. The separation unit 104 may be operated at a temperature suitable to separate the hydrocarbon feed stream 102 into at least the greater boiling point effluent 106 and the lesser boiling point effluent 108. In embodiments, the separation unit 104 may be operated at a temperature of from 200 degrees Celsius (° C.) to 500° C. For example, the separation unit 104 may be operated at a temperature of from 200° C. to 450° C., from 200° C. to 400° C., from 200° C. to 350° C., from 200° C. to 300° C., from 200° C. to 250° C., from 250° C. to 500° C., from 250° C. to 450° C., from 250° C. to 400° C., from 250° C. to 350° C., from 250° C. to 300° C., from 300° C. to 500° C., from 300° C. to 450° C., from 300° C. to 400° C., from 300° C. to 350° C., from 350° C. to 500° C., from 350° C. to 450° C., from 350° C. to 400° C., from 400° C. to 500° C., from 400° C. to 450° C., or from 450° C. to 500° C. In embodiments, the separation unit 104 may be operated at a temperature of 350° C.

The greater boiling point effluent 106 may be passed to the first fluid catalytic cracking unit 120, which may include a first cracking reaction zone 122. The greater boiling point effluent 106 may generally include hydrocarbons boiling at temperatures greater than the temperature that the separation unit 104 is operated at. In embodiments, the greater boiling point effluent 106 may include hydrocarbons boiling at temperatures greater than 200° C. For example, the greater boiling point effluent 106 may include hydrocarbons boiling at temperatures greater than 250° C., greater than 300° C., greater than 350° C., greater than 400° C., greater than 450° C., or greater than 500° C. In embodiments, the greater boiling point effluent 106 may have an American Petroleum Institute (API) gravity greater than or equal to 30 degrees (°). For example, the greater boiling point effluent may have an American Petroleum Institute (API) gravity greater than or equal to 32°, greater than or equal to 34°, greater than or equal to 36°, greater than or equal to 38°, greater than or equal to 40°, greater than or equal to 42°, greater than or equal to 44°, greater than or equal to 46°, greater than or equal to 48°, or greater than or equal to 50°.

The greater boiling point effluent 106 may be combined or mixed with a first multicomponent catalyst 124 and catalytically cracked to produce a mixture of a first spent multicomponent catalyst 125 and a first cracked effluent 126. Steam 127 may be added to the first cracking reaction zone 122 to further increase the temperature in the first cracking reaction zone 122. The first spent multicomponent catalyst 125 may be separated from the first cracked effluent 126 and passed to a first regeneration zone 162 of the regenerator 160, in which the first spent multicomponent catalyst 125 is regenerated to produce a first regenerated multicomponent catalyst 123. The first regenerated multicomponent catalyst 123 is then passed back to the first cracking reaction zone 122 as the multicomponent catalyst 124.

Referring now to FIG. 2, the first fluid catalytic cracking unit 120 may include a first catalyst/feed mixing zone 128, the first cracking reaction zone 122, a first catalyst separation zone 130, and a first stripping zone 132. The greater boiling point effluent 106 may be introduced to the first catalyst/feed mixing zone 128, where the greater boiling point effluent 106 may be mixed with the first multicomponent catalyst 124. During steady state operation of the system 100, the first multicomponent catalyst 124 may be the first regenerated multicomponent catalyst 123 that is passed to the first catalyst/feed mixing zone 128 from one or more first catalyst hoppers 174. The first catalyst hoppers 174 receive the first regenerated multicomponent catalyst 123 from the regenerator 160 following regeneration of the first spent multicomponent catalyst 125. At initial start-up of the system 100, the first multicomponent catalyst 124 may include fresh multicomponent catalyst (not shown), which may be first multicomponent catalyst 124 that has not been circulated through the first fluid catalytic cracking unit 120 and the regenerator 160. In embodiments, fresh multicomponent catalyst may also be introduced to first catalyst hopper 174 during operation of the system 100 so that the first multicomponent catalyst 124 introduced to the first catalyst/feed mixing zone 128 comprises a mixture of fresh multicomponent catalyst and first regenerated multicomponent catalyst 123. Fresh multicomponent catalyst may be introduced to the first catalyst hopper 174 periodically during operation to replenish lost first multicomponent catalyst 124 or compensate for first spent multicomponent catalyst 125 that becomes permanently deactivated, such as through heavy metal accumulation in the catalyst.

In embodiments, one or more supplemental feed streams (not shown) may be combined with the greater boiling point effluent 106 before introduction of the greater boiling point effluent 106 to the first catalyst/feed mixing zone 128. In other embodiments, one or more supplemental feed streams may be added directly to the first catalyst/feed mixing zone 128, where the supplemental feed stream may be mixed with the greater boiling point effluent 106 and the first multicomponent catalyst 124 prior to introduction into the first cracking reaction zone 122. As previously described, the supplemental feed stream may include one or more of vacuum residues, tar sands, bitumen, atmospheric residues, vacuum gas oils, demetalized oils, naphtha streams, or combinations of these.

The mixture comprising the greater boiling point effluent 106 and the first multicomponent catalyst 124 may be introduced to the first cracking reaction zone 122. The mixture of the greater boiling point effluent 106 and first multicomponent catalyst 124 may be introduced to a top portion of the first cracking reaction zone 122. In embodiments, the first cracking reaction zone 122 may be a downflow or “downer” reactor in which the reactants flow from the first catalyst/feed mixing zone 128 downward through the first cracking reaction zone 122 to the first separation zone 130. Steam 127 may be introduced to the top portion of the first cracking reaction zone 122 to provide additional heating to the mixture of the greater boiling point effluent 106 and the first multicomponent catalyst 124. The greater boiling point effluent 106 may be reacted by contact with the first multicomponent catalyst 124 in the first cracking reaction zone 122, which causes at least a portion of the greater boiling point effluent 106 to undergo one or more catalytic cracking reactions to form one or more cracking reaction products, which may include one or more olefins. The first multicomponent catalyst 124, which may have a temperature equal to or greater than the reaction temperature of the first cracking reaction zone 122, may transfer heat to the greater boiling point effluent 106 to promote the endothermic cracking reaction.

It should be understood that the first cracking reaction zone 122 of the first fluid catalytic cracking unit 120 depicted in FIG. 2 is a simplified schematic of one particular embodiment of the first cracking reaction zone 122 of a fluid catalytic cracking unit, and other configurations of the first cracking reaction zone 122 may be suitable for incorporation into the system 100. For example, in embodiments, the first cracking reaction zone 122 may be an up-flow cracking reaction zone. In embodiments, the first fluid catalytic cracking unit 120 may be operated under high-severity conditions. That is, in embodiments, the reaction temperature of the first cracking reaction zone 122 may be from 580° C. to 750° C. For example, the reaction temperature of the first cracking reaction zone 122 may be from 580° C. to 740° C., from 580° C. to 720° C., from 580° C. to 700° C., from 580° C. to 680° C., from 580° C. to 660° C., from 580° C. to 640° C., from 580° C. to 620° C., from 580° C. to 600° C., from 600° C. to 750° C., from 600° C. to 740° C., from 600° C. to 720° C., from 600° C. to 700° C., from 600° C. to 680° C., from 600° C. to 660° C., from 600° C. to 640° C., from 600° C. to 620° C., from 620° C. to 750° C., from 620° C. to 740° C., from 620° C. to 720° C., from 620° C. to 700° C., from 620° C. to 680° C., from 620° C. to 660° C., from 620° C. to 640° C., from 640° C. to 750° C., from 640° C. to 740° C., from 640° C. to 720° C., from 640° C. to 700° C., from 640° C. to 680° C., from 660° C. to 750° C., from 660° C. to 740° C., from 660° C. to 720° C., from 660° C. to 700° C., from 660° C. to 680° C., from 680° C. to 750° C., from 680° C. to 740° C., from 680° C. to 720° C., from 680° C. to 700° C., from 700° C. to 750° C., from 700° C. to 740° C., from 700° C. to 720° C., from 720° C. to 750° C., from 720° C. to 740° C., or from 740° C. to 750° C. When the reaction temperature of the first cracking reaction zone 122 is greater than, for example, 750° C., the greater boiling point effluent 106 may be over-cracked. That is, light olefins in the greater boiling point effluent 106 may be cracked in addition to the relatively larger hydrocarbons and, as a result, the yield of light olefins from the system 100 may be reduced.

Following the cracking reaction in the first cracking reaction zone 122, the contents of the first cracking reaction zone 122 may include the first spent multicomponent catalyst 125 and the first cracked effluent 126, which may then be passed to the first separation zone 130. In the first separation zone 130, the first spent multicomponent catalyst 125 may be separated from at least a portion of the first cracked effluent 126. In embodiments, the first separation zone 130 may include one or more gas solid separators, such as one or more cyclones. The first spent multicomponent catalyst 125 exiting from the first separation zone 130 may retain at least a portion of the first cracked effluent 126.

Following separation from the first cracked effluent 126 in the first separation zone 130, the first spent multicomponent catalyst 125, which may include at least a portion of the first cracked effluent 126 retained in the first spent multicomponent catalyst 125, may be passed to the first stripping zone 132, where additional portions of the first cracked effluent 126 are stripped from the first spent multicomponent catalyst 125 and recovered as a first stripped effluent 134. The first stripped effluent 134 may be passed to one or more downstream unit operations or combined with one or more other streams for further processing. Steam 133 may be introduced to the stripping zone 132 to facilitate stripping the first cracked effluent 126 from the first spent multicomponent catalyst 125. The first stripped effluent 134, which may include at least a portion of the steam 133 introduced to the first stripping zone 132, may be discharged from the first stripping zone 132, at which point first stripped effluent 134 may pass through cyclone separators (not shown) and out of the stripper vessel (not shown). The first stripped effluent 134 may be directed to one or more product recovery systems in accordance with known methods in the art. The first stripped effluent 134 may also be combined with one or more other streams, such as the first cracked effluent 126, for example. The first spent multicomponent catalyst 125, after having been stripped of at least a portion of the first cracked effluent 126 remaining in the first spent multicomponent catalyst 125, may be then passed to the first regeneration zone 162 of the regenerator 160, which will be subsequently described in more detail in the present disclosure.

Referring again to FIG. 1, the lesser boiling point effluent 108 may be passed to a second fluid catalytic cracking unit 140 that includes a second cracking reaction zone 142. The lesser boiling point effluent 108 may generally include hydrocarbons boiling at temperatures less than the temperature that the separation unit 104 is operated at. In embodiments, the lesser boiling point effluent 108 may include hydrocarbons boiling at temperatures less than 500° C. For example, the lesser boiling point effluent 108 may include hydrocarbons boiling at temperatures less than 450° C., less than 400° C., less than 350° C., less than 300° C., less than 250° C., or less than 200° C.

The lesser boiling point effluent 108 may be mixed with a second multicomponent catalyst 144 and cracked to produce a second spent multicomponent catalyst 145 and a second cracked effluent 146. Steam 127 may also be added to the second cracking reaction zone 142 to increase the temperature in the second cracking reaction zone 142. The second spent multicomponent catalyst 145 may be separated from the second cracked effluent 146 and passed to a second regeneration zone 164 of the regenerator 160, where the second spent multicomponent catalyst 145 is regenerated to produce a regenerated multicomponent catalyst 143. In embodiments, the second spent multicomponent catalyst 145 in the second regeneration zone 164 may be maintained separate from the first spent multicomponent catalyst 125 in the first regeneration zone 162 by a porous separation zone 178 disposed between the first regeneration zone 162 and the second regeneration zone 164. In other embodiments, the second regeneration zone 164 may not be separated from the first regeneration zone 162 by the porous separation zone 178, and the first spent multicomponent catalyst 125 and the second spent multicomponent catalyst 145 may be regenerated together in a single regeneration zone. The second regenerated multicomponent catalyst 143 may be then passed back to the second cracking reaction zone 142 as the second multicomponent catalyst 144. The first cracking reaction zone 122 and the second cracking reaction zone 142 may be operated in parallel.

Referring again to FIG. 2, the second fluid catalytic cracking unit 140 may include a second catalyst/feed mixing zone 148, the second cracking reaction zone 142, a second separation zone 150, and a second stripping zone 152. The lesser boiling point effluent 108 may be introduced to the second catalyst/feed mixing zone 148, where the lesser boiling point effluent 108 may be mixed with the second multicomponent catalyst 144. During steady state operation of the system 100, the second multicomponent catalyst 144 may include second regenerated multicomponent catalyst 143 that is passed to the second catalyst/feed mixing zone 148 from one or more second catalyst hoppers 176. The second catalyst hopper 176 may receive the second regenerated multicomponent catalyst 143 from the regenerator 160 following regeneration of the second spent multicomponent catalyst 145. At initial start-up of the system 100, the second multicomponent catalyst 144 may include fresh multicomponent catalyst (not shown), which may be multicomponent catalyst that has not been circulated through the second fluid catalytic cracking unit 140 and the regenerator 160. In embodiments, fresh multicomponent catalyst may also be introduced to the second catalyst hopper 176 during operation of the system 100 so that the second multicomponent catalyst 144 introduced to the second catalyst/feed mixing zone 148 comprises a mixture of fresh multicomponent catalyst and second regenerated multicomponent catalyst 143. Fresh multicomponent catalyst may be introduced to the second catalyst hopper 176 periodically during operation to replenish lost second multicomponent catalyst 144 or compensate for second spent multicomponent catalyst 145 that becomes permanently deactivated, such as through heavy metal accumulation in the catalyst.

In embodiments, one or more supplemental feed streams (not shown) may be combined with the lesser boiling point effluent 108 before introduction of the lesser boiling point effluent 108 to the second catalyst/feed mixing zone 148. In other embodiments, one or more supplemental feed streams may be added directly to the second catalyst/feed mixing zone 148, where the supplemental feed stream may be mixed with the lesser boiling point effluent 108 and the multicomponent catalyst 144 prior to introduction into the second cracking reaction zone 142. The supplemental feed stream may include one or more naphtha streams or other lesser boiling point hydrocarbon streams.

The mixture comprising the lesser boiling point effluent 108 and the second multicomponent catalyst 144 may be introduced to the second cracking reaction zone 142. The mixture of the lesser boiling point effluent 108 and second multicomponent catalyst 144 may be introduced to a top portion of the second cracking reaction zone 142. In embodiments, the second cracking reaction zone 142 may be a downflow or “downer” reactor in which the reactants flow from the second catalyst/feed mixing zone 148 downward through the second cracking reaction zone 142 to the second separation zone 150. Steam 127 may be introduced to the top portion of the second cracking reaction zone 142 to provide additional heating to the mixture of the lesser boiling point effluent 108 and the second multicomponent catalyst 144. The lesser boiling point effluent 108 may be reacted by contact with the second multicomponent catalyst 144 in the second cracking reaction zone 142, which causes at least a portion of the lesser boiling point effluent 108 to undergo one or more catalytic cracking reactions to form one or more cracking reaction products, which may include one or more olefins. The second multicomponent catalyst 144, which has a temperature equal to or greater than the reaction temperature of the second cracking reaction zone 142, may transfer heat to the lesser boiling point effluent 108 to promote the endothermic cracking reaction.

It should be understood that the second cracking reaction zone 142 of the second fluid catalytic cracking unit 140 depicted in FIG. 2 is a simplified schematic of one particular embodiment of the second cracking reaction zone 142, and other configurations of the second cracking reaction zone 142 may be suitable for incorporation into the system 100. For example, in embodiments, the second cracking reaction zone 142 may be an up-flow cracking reaction zone. In embodiments, the second fluid catalytic cracking unit 140 may be operated under high-severity conditions. That is, in embodiments, the reaction temperature of the second cracking reaction zone 142 may be from 580° C. to 750° C. For example, the reaction temperature of the second cracking reaction zone 142 may be from 580° C. to 740° C., from 580° C. to 720° C., from 580° C. to 700° C., from 580° C. to 680° C., from 580° C. to 660° C., from 580° C. to 640° C., from 580° C. to 620° C., from 580° C. to 600° C., from 600° C. to 750° C., from 600° C. to 740° C., from 600° C. to 720° C., from 600° C. to 700° C., from 600° C. to 680° C., from 600° C. to 660° C., from 600° C. to 640° C., from 600° C. to 620° C., from 620° C. to 750° C., from 620° C. to 740° C., from 620° C. to 720° C., from 620° C. to 700° C., from 620° C. to 680° C., from 620° C. to 660° C., from 620° C. to 640° C., from 640° C. to 750° C., from 640° C. to 740° C., from 640° C. to 720° C., from 640° C. to 700° C., from 640° C. to 680° C., from 660° C. to 750° C., from 660° C. to 740° C., from 660° C. to 720° C., from 660° C. to 700° C., from 660° C. to 680° C., from 680° C. to 750° C., from 680° C. to 740° C., from 680° C. to 720° C., from 680° C. to 700° C., from 700° C. to 750° C., from 700° C. to 740° C., from 700° C. to 720° C., from 720° C. to 750° C., from 720° C. to 740° C., or from 740° C. to 750° C. When the reaction temperature of the second cracking reaction zone 122 is less than, for example, 580° C., the lesser boiling point effluent 108 may be under cracked. That is, a portion of the relatively smaller hydrocarbons in the lesser boiling point effluent 108 may not be cracked and, as a result, the yield of light olefins from the system 100 may be reduced. In embodiments, the reaction temperature in the second cracking reaction zone 122 may be greater than the reaction temperature in the first cracking reaction zone 122.

Following the cracking reaction in the second cracking reaction zone 142, the contents of the second cracking reaction zone 142 may include the second spent multicomponent catalyst 145 and the second cracked effluent 146, which may be passed to the second separation zone 150. In the second separation zone 150, the second spent multicomponent catalyst 145 may be separated from at least a portion of the second cracked effluent 146. In embodiments, the second separation zone 150 may include one or more gas solid separators, such as one or more cyclones. The second spent multicomponent catalyst 145 exiting from the second separation zone 150 may retain at least a portion of the second cracked effluent 146.

Following separation from the second cracked effluent 146 in the second separation zone 150, the second spent multicomponent catalyst 145, which may include at least a portion of the second cracked effluent 146 retained in the second spent multicomponent catalyst 145, may be passed to the second stripping zone 152, where additional portions of the second cracked effluent 146 are stripped from the second spent multicomponent catalyst 145 and recovered as a second stripped effluent 154. The second stripped effluent 154 may be passed to one or more downstream unit operations or combined with one or more other streams for further processing. Steam 133 may be introduced to the second stripping zone 152 to facilitate stripping the second cracked effluent 146 from the second spent multicomponent catalyst 145. The second stripped effluent 154, which may include at least a portion of the steam 133 introduced to the second stripping zone 152, may be passed out of the second stripping zone 152, at which point the second stripped effluent 154 may pass through cyclone separators (not shown) and out of the stripper vessel (not shown). The second stripped effluent 154 may be directed to one or more product recovery systems in accordance with known methods in the art. The second stripped effluent 154 may also be combined with one or more other streams, such as the second cracked effluent 146. The second spent multicomponent catalyst 145, after having been stripped of at least the additional portion of second cracked effluent 146 remaining in the second spent multicomponent catalyst 145, may then be passed to the second regeneration zone 164 of the regenerator 160, which will be subsequently described in more detail in the present disclosure.

Referring again to FIG. 1, the first fluid catalytic cracking unit 120 and the second fluid catalytic cracking unit 140 may share the regenerator 160. In embodiments, the regenerator 160 may be a two-zone regenerator that includes the first regeneration zone 162 and the second regeneration zone 164. The first spent multicomponent catalyst 125 may be regenerated in the first regeneration zone 162 to produce the first regenerated multicomponent catalyst 124, and the second spent multicomponent catalyst 145 may be regenerated in the second regeneration zone 162 to produce the second regenerated multicomponent catalyst 144. In other embodiments, the regenerator may be a single-zone regenerator that include only one regeneration zone. In embodiments where the regenerator is a single-zone regenerator, the first spent multicomponent catalyst 125 and the second spent multicomponent catalyst 145 may both be regenerated in the one regeneration zone to produce the first regenerated multicomponent catalyst 124 and the second regenerated multicomponent catalyst 144.

Referring again to FIG. 2, the regenerator 160 may include a first riser 166 and a second riser 168. The first riser 166 may be positioned between the first stripping zone 132 and the first regeneration zone 162. The first spent multicomponent catalyst 125 and combustion gas 170 may be introduced to a bottom end of the first riser 166. The combustion gases 170 may include one or more of combustion air, oxygen, fuel gas, fuel oil, or combinations of these. The combustion gases 170 may convey the first spent multicomponent catalyst 125 upwards through the first riser 166 to the first regeneration zone 162, where coke deposits and residual reactants and reaction products are at least partially oxidized (combusted). The coke deposited on the first spent multicomponent catalyst 125 in the first cracking reaction zone 122 may begin to oxidize in the presence of the combustion gases 170 in the first riser 166 on the way upward to the first regeneration zone 162. The second riser 168 may be positioned between the second stripping zone 152 and the second regeneration zone 164, where coke deposits and residual reactants and reaction products are at least partially oxidized (combusted). The second spent multicomponent catalyst 145 and combustion gas 170 may be introduced to a bottom end of the second riser 168. The combustion gases 170 may convey the second spent multicomponent catalyst 145 upwards through the second riser 168 to the second regeneration zone 164. The coke deposited on the second spent multicomponent catalyst 145 in the second cracking reaction zone 142 may begin to oxidize in the presence of the combustion gases 170 in the second riser 168 on the way upward to the second regeneration zone 164.

The system 100 may include a first catalyst hopper 174 disposed between the first regeneration zone 162 of the regenerator 160 and the first fluid catalytic cracking unit 120 and a second catalyst hopper 176 positioned between the second regeneration zone 164 of the regenerator 160 and the second fluid catalytic cracking unit 140. The first regenerated multicomponent catalyst 123 may pass from the first regeneration zone 162 to the first catalyst hopper 174, where the first regenerated multicomponent catalyst 123 may accumulate prior to passing from the first catalyst hopper 174 to the first catalyst/feed mixing zone 128 as the first multicomponent catalyst 124. The first regenerated multicomponent catalyst 123, which may be at an elevated temperature equal to or greater than the reaction temperature in the first cracking reaction zone 122, may provide heat for the endothermic cracking reaction in the first cracking reaction zone 122. The second regenerated multicomponent catalyst 144 may pass from the second regeneration zone 164 to the second catalyst hopper 176, where the second regenerated multicomponent catalyst 144 may accumulate prior to passing from the second catalyst hopper 176 to the second catalyst/feed mixing zone 148 as the second multicomponent catalyst 144. The second regenerated multicomponent catalyst 143, which may be at an elevated temperature equal to or greater than the reaction temperature in the second cracking reaction zone 142, may provide heat for the endothermic cracking reaction in the first cracking reaction zone 142.

As noted previously, the systems and methods of the present disclosure include contacting the hydrocarbon feed with a multicomponent catalyst, which may include a first large pore molecular sieve, such as zeolite Beta, a second large pore molecular sieve, such as USY zeolite, and, optionally, a shape selective cracking catalyst, such as ZSM-5. The inclusion of two or more different zeolitic components may allow for an increase of the selectivity and yield of light olefins across the entire range of some unconventional hydrocarbon feeds for fluid catalytic cracking processes, such as crude oil. Without being bound by any particular theory, it is believed that the different zeolitic components may be active enough to promote the catalytic cracking of lighter hydrocarbons, such as those present in the lesser boiling point effluent 108, and mild enough to avoid the excessive catalytic cracking of heavier hydrocarbons, such as those present in the greater boiling point effluent 106. This balanced activity provided by the mixture of zeolite components may increase the yield of products, such as light olefins, from the catalytic cracking of both light hydrocarbons and heavy hydrocarbons. In embodiments, the first multicomponent catalysts 124 and the second multicomponent catalyst 144 may include a first large pore molecular sieve, a second large pore molecular sieve, a shape selective cracking catalyst, or combinations of these. In some embodiments, the first multicomponent catalysts 124 and the second multicomponent catalyst 144 may be the same multicomponent catalyst. In other embodiments, the first multicomponent catalysts 124 and the second multicomponent catalyst 144 may be different multicomponent catalysts. That is, in some embodiments, the first multicomponent catalysts 124 and the second multicomponent catalyst 144 may include one or more different components or may include the same components in different amounts.

The first large pore molecular sieve may be operable to crack at least a portion of the greater boiling point effluent 106, the lesser boiling point effluent 108, or both. In embodiments, the first large pore molecular sieve may comprise a *BEA framework type zeolite, such as zeolite Beta. As used in the present disclosure, “zeolite Beta” refers to zeolite having a *BEA framework type according to the International Union of Pure and Applied Chemistry (IUPAC) zeolite nomenclature and consisting of silica and alumina. The molar ratio of silica to alumina in the zeolite Beta may be at least 5, at least 10, at least 25, or even at least 50. For example, the molar ratio of silica to alumina in the zeolite Beta may be from 5 to 50, from 5 to 25, from 5 to 10, from 10 to 50, from 10 to 25, or from 25 to 50. In some embodiments, the zeolite Beta may be in the form of H-Beta, which is the acidic form of zeolite Beta typically derived from NH₄-Beta via calcination. In other embodiments, the zeolite Beta may be stabilized by direct reaction with phosphoric acid (H₃PO₄) or by impregnation with ammonium hydrogen phosphate (NH₄)₂HPO₄.

In embodiments, the first multicomponent catalysts 124 and the second multicomponent catalyst 144 may each include the first large pore molecular sieve in an amount of from 10 wt. % to 40 wt. % based on the total weight of the first multicomponent catalysts 124 and the second multicomponent catalyst 144. For example, the first multicomponent catalysts 124 and the second multicomponent catalyst 144 may each include from 10 wt. % to 35 wt. %, from 10 wt. % to 30 wt. %, from 10 wt. % to 25 wt. %, from 10 wt. % to 20 wt. %, from 10 wt. % to 15 wt. %, from 15 wt. % to 40 wt. %, from 15 wt. % to 35 wt. %, from 15 wt. % to 30 wt. %, from 15 wt. % to 25 wt. %, from 15 wt. % to 20 wt. %, from 20 wt. % to 40 wt. %, from 20 wt. % to 35 wt. %, from 20 wt. % to 30 wt. %, from 20 wt. % to 25 wt. %, from 25 wt. % to 40 wt. %, from 25 wt. % to 35 wt. %, from 25 wt. % to 30 wt. %, from 30 wt. % to 40 wt. %, from 30 wt. % to 35 wt. %, or from 35 wt. % to 40 wt. % of the first large pore molecular sieve based on the total weight of each of the first multicomponent catalysts 124 and the second multicomponent catalyst 144.

The second large pore molecular sieve may be operable to produce one or more olefins from the greater boiling point effluent 106, the lesser boiling point effluent 108, or both. In embodiments, the second large pore molecular sieve may comprise an FAU framework type zeolite, such as an ultrastable Y (USY) zeolite. USY zeolites may be produced via the dealumination of zeolite Y. As used in the present disclosure, “zeolite Y” refers to zeolite having a FAU framework type according to the IUPAC zeolite nomenclature and consisting of silica and alumina. Without being bound by any particular theory, it is believed that the dealumination of zeolite Y may result in a USY zeolite having a reduced number of acid sites. This reduced number of acid sites may result in a reduction of the rates of secondary reactions in the system 100, such as the dehydrogenation or hydrogenation of olefins produced in the system 100, when compared to zeolite Y that has not been dealuminated. As a result, USY zeolite may produce a greater yield of olefins when compared to zeolite Y. The molar ratio of silica to alumina in the USY zeolite may be at least 5, at least 10, at least 25, or even at least 50. For example, the molar ratio of silica to alumina in the USY zeolite may be from 5 to 50, from 5 to 25, from 5 to 10, from 10 to 50, from 10 to 25, or from 25 to 50. In embodiments, the USY zeolite may also comprise one or more transition metals, such as zirconium, titanium, or hafnium, substituted into the framework of the zeolite.

In embodiments, the first multicomponent catalysts 124 and the second multicomponent catalyst 144 may each include the second large pore molecular sieve in an amount of from 10 wt. % to 30 wt. % based on the total weight of the first multicomponent catalysts 124 and the second multicomponent catalyst 144. For example, the first multicomponent catalysts 124 and the second multicomponent catalyst 144 may each include from 10 wt. % to 25 wt. %, from 10 wt. % to 20 wt. %, from 10 wt. % to 15 wt. %, from 15 wt. % to 30 wt. %, from 15 wt. % to 25 wt. %, from 15 wt. % to 20 wt. %, from 20 wt. % to 30 wt. %, from 20 wt. % to 25 wt. %, or from 25 wt. % to 30 wt. % of the second large pore molecular sieve based on the total weight of each of the first multicomponent catalysts 124 and the second multicomponent catalyst 144.

The shape selective cracking catalyst may be operable to crack at least a portion of the greater boiling point effluent 106, the lesser boiling point effluent 108, or both, to produce one or more light olefins, such as ethylene and propylene. Without being bound by any particular theory, it is believed that the shape selective zeolite may have a greater propensity to crack the relatively lighter hydrocarbons, such as those present in lesser boiling point process streams and those produced by the catalytic cracking of heavier hydrocarbons by the large pore molecular sieves. As a result, the inclusion of the shape selective cracking catalyst may increase the yield of products, such as light olefins, when compared to multicomponent catalysts that do not include the shape selective cracking catalyst. In embodiments, the shape selective cracking catalyst may comprise an MFI framework type zeolite, such as ZSM-5. As used in the present disclosure, “ZSM-5” refers to zeolites having an MFI framework type according to the IUPAC zeolite nomenclature and consisting of silica and alumina. ZSM-5 refers to “Zeolite Socony Mobil-5” and is a pentasil family zeolite that can be represented by the chemical formula NaₙAlₙSi₉₆₋ₙO₁₉₂.16H₂O, where 0<n<27. The molar ratio of silica to alumina in the ZSM-5 may be at least 5, at least 10, at least 25, or even at least 50. For example, the molar ratio of silica to alumina in the ZSM-5 may be from 5 to 50, from 5 to 25, from 5 to 10, from 10 to 50, from 10 to 25, or from 25 to 50.

In embodiments, the first multicomponent catalysts 124 and the second multicomponent catalyst 144 may each include the shape selective cracking catalyst in an amount of from 0 wt. % to 10 wt. % based on the total weight of each of the first multicomponent catalysts 124 and the second multicomponent catalyst 144. For example, the first multicomponent catalysts 124 and the second multicomponent catalyst 144 may each include from 0 wt. % to 8 wt. %, from 0 wt. % to 6 wt. %, from 0 wt. % to 4 wt. %, from 0 wt. % to 2 wt. %, from 0 wt. % to 1 wt. %, from 1 wt. % to 10 wt. %, from 1 wt. % to 8 wt. %, from 1 wt. % to 6 wt. %, from 1 wt. % to 4 wt. %, from 1 wt. % to 2 wt. %, from 2 wt. % to 10 wt. %, from 2 wt. % to 8 wt. %, from 2 wt. % to 6 wt. %, from 2 wt. % to 4 wt. %, from 4 wt. % to 10 wt. %, from 4 wt. % to 8 wt. %, from 4 wt. % to 6 wt. %, from 6 wt. % to 10 wt. %, from 6 wt. % to 8 wt. %, or from 8 wt. % to 10 wt. % of the shape selective cracking catalyst based on the total weight of each of the first multicomponent catalysts 124 and the second multicomponent catalyst 144.

In embodiments, one or more of the zeolitic components of the first multicomponent catalysts 124 and the second multicomponent catalyst 144 may include one or more phosphorous-containing compounds, such as phosphorous pentoxide (P₂O₅). In embodiments, one or more of the zeolitic components of the first multicomponent catalysts 124 and the second multicomponent catalyst 144 may include one or more phosphorous-containing compounds in an amount of from 1 wt. % to 20 wt. % based on the total weight of each zeoitic component. For example, one or more of the zeolitic components of the first multicomponent catalysts 124 and the second multicomponent catalyst 144 may include one or more phosphorous-containing compounds in an amount of from 1 wt. % to 15 wt. %, from 1 wt. % to 10 wt. %, from 1 wt. % to 5 wt. %, from 5 wt. % to 20 wt. %, from 5 wt. % to 15 wt. %, from 5 wt. % to 10 wt. %, from 10 wt. % to 20 wt. %, from 10 wt. % to 15 wt. %, or from 15 wt. % to 20 wt. % based on the total weight of each zeoitic component. Without being bound by any particular theory, it is believe that phosphorus-containing compounds may stabilize the structure of the zeolitic framework structure by preventing the segregation of the framework alumina, which improves the hydrothermal stability of the zeolitic component. This may reduce the dealumination of the zeolitic component that occurs during steaming, which can lead to a reduction in acidity and catalytic activity of the zeolitic component.

In embodiments, one or more of the zeolitic components of the first multicomponent catalysts 124 and the second multicomponent catalyst 144 may include one or more rare earth metals, such as lanthanum, cerium, dysprosium, europium, gadolinium, holmium, lutetium, neodymium, praseodymium, promethium, samarium, scandium, terbium, thulium, ytterbium, yttrium, or combinations of these. In embodiments, one or more of the zeolitic components of the first multicomponent catalysts 124 and the second multicomponent catalyst 144 may include one or more rare earth metals in an amount of from 1 wt. % to 5 wt. % based on the total weight of each zeoitic component. For example, one or more of the zeolitic components of the first multicomponent catalysts 124 and the second multicomponent catalyst 144 may include one or more phosphorous-containing compounds in an amount of from 1 wt. % to 4 wt. %, from 1 wt. % to 3 wt. %, from 1 wt. % to 2 wt. %, from 2 wt. % to 5 wt. %, from 2 wt. % to 4 wt. %, from 2 wt. % to 3 wt. %, from 3 wt. % to 5 wt. %, from 3 wt. % to 4 wt. %, or from 4 wt. % to 5 wt. % based on the total weight of each zeoitic component. Without being bound by any particular theory, it is believe that rare earth metals improve the stability of the unit cells of the zeolitic component, increase the catalytic activity of the zeolitic component, or both. Moreover, it is believed that rare earth metals can function as vanadium traps, which act to sequester vanadium in the feed and prevent deleterious effects that vanadium may have on the zeolitic component.

In embodiments, the first multicomponent catalysts 124 and the second multicomponent catalyst 144 may each include one or more binder materials, such as alumina-containing compounds or silica-containing compounds (including compounds containing alumina and silica). As used in the present disclosure, “binder materials” refer to materials which may serve to “glue” or otherwise hold components of the first multicomponent catalysts 124 and the second multicomponent catalyst 144 together. Binder materials may improve the attrition resistance of the first multicomponent catalysts 124 and the second multicomponent catalyst 144. The binders may comprise alumina (such as amorphous alumina), silica-alumina (such as amorphous silica-alumina), or silica (such as amorphous silica). According to one or more embodiments, the binder material may comprise pseudoboehmite. As used in the present disclosure, “pseudoboehmite” refers to an aluminum-containing compound with the chemical composition AlO(OH) consisting of crystalline boehmite. While boehmite generally refers to aluminum oxide hydroxide as well, pseudoboehmite generally has a greater amount of water than boehmite. The binders, such as pseudoboehmite, may be peptized with an acid, such as a mono-protic acid, such as nitric acid (HNO₃) or hydrochloric acid (HCl). In embodiments, the first multicomponent catalysts 124 and the second multicomponent catalyst 144 may each include the one or more binders in an amount of from 10 wt. % to 30 wt. % based on the total weight of the multicomponent catalysts 124, 144. For example, the first multicomponent catalysts 124 and the second multicomponent catalyst 144 may each include the one or more binders in an amount of from 10 wt. % to 25 wt. %, from 10 wt. % to 20 wt. %, from 10 wt. % to 15 wt. %, from 15 wt. % to 30 wt. %, from 15 wt. % to 25 wt. %, from 15 wt. % to 20 wt. %, from 20 wt. % to 30 wt. %, from 20 wt. % to 25 wt. %, or from 25 wt. % to 30 wt. % based on the total weight of each of the first multicomponent catalysts 124 and the second multicomponent catalyst 144.

In embodiments, the first multicomponent catalysts 124 and the second multicomponent catalyst 144 may each include one or more matrix materials. As use in the present disclosure, “matrix materials” may refer to a clay material such as kaolin. Without being bound by any particular theory, it is believed that the matrix materials of the first multicomponent catalysts 124 and the second multicomponent catalyst 144 may serve both physical and catalytic functions. Physical functions may include providing particle integrity and attrition resistance, acting as a heat transfer medium, and providing a porous structure to allow diffusion of hydrocarbons into and out of the catalyst microspheres. The matrix materials may also affect catalyst selectivity, product quality, and resistance to poisons. The matrix materials may tend to exert its strongest influence on overall catalytic properties for those reactions that directly involve relatively large molecules.

In embodiments, the matrix materials may include kaolin. As used in the present disclosure, “kaolin” refers to a clay material that has a relatively large amount (such as at least about 50 wt. %, at least 60 wt. %, at least 70 wt. %, at least 80 wt. %, at least 90 wt. %, or at least 95 wt. %) of kaolinite, which can be represented by the chemical formula Al₂Si₂O₅(OH)₄. In embodiments, the first multicomponent catalysts 124 and the second multicomponent catalyst 144 may each include one or more matrix materials in an amount of from 30 wt. % to 60 wt. % based on the total weight of each of the first multicomponent catalysts 124 and the second multicomponent catalyst 144. For example, the first multicomponent catalysts 124 and the second multicomponent catalyst 144 may each include one or more matrix materials in an amount of from 30 wt. % to 55 wt. %, from 30 wt. % to 50 wt. %, from 30 wt. % to 45 wt. %, from 30 wt. % to 40 wt. %, from 30 wt. % to 35 wt. %, from 35 wt. % to 60 wt. %, from 35 wt. % to 55 wt. %, from 35 wt. % to 50 wt. %, from 35 wt. % to 45 wt. %, from 35 wt. % to 40 wt. %, from 40 wt. % to 60 wt. %, from 40 wt. % to 55 wt. %, from 40 wt. % to 50 wt. %, from 40 wt. % to 45 wt. %, from 45 wt. % to 60 wt. %, from 45 wt. % to 55 wt. %, from 45 wt. % to 50 wt. %, from 50 wt. % to 60 wt. %, from 50 wt. % to 55 wt. %, or from 55 wt. % to 60 wt. % based on the total weight of each of the first multicomponent catalysts 124 and the second multicomponent catalyst 144.

In embodiments, the first multicomponent catalysts 124 and the second multicomponent catalyst 144 may be in the form of shaped microparticles, such as microspheres. As used in the present disclosure, “microparticles” refer to particles having of size of from 0.1 microns and 100 microns. The size of a microparticle refers to the maximum length of a particle from one side to another, measured along the longest distance of the microparticle. For example, a spherically shaped microparticle has a size equal to its diameter, or a rectangular prism shaped microparticle has a maximum length equal to the hypotenuse stretching from opposite corners. In embodiments, each zeolitic component of the multicomponent catalysts 124, 144 may be included in each microparticle. However, in other embodiments, microparticles may be mixed, where the microparticles contain only a portion of the first multicomponent catalysts 124 and the second multicomponent catalyst 144. For example, a mixture of three microparticle types may be included in the first multicomponent catalysts 124 and the second multicomponent catalyst 144, where one type of microparticle includes only ZSM-5, one type of microparticle includes only zeolite Beta, and one microparticle type includes only USY zeolite.

The first multicomponent catalysts 124 and the second multicomponent catalyst 144 may be formed by a variety of processes. According to one embodiment, the matrix material may be mixed with a fluid such as water to form a slurry, and the zeolites may be separately mixed with a fluid such as water to form a slurry. The matrix material slurry and the zeolite slurry may be combined under stirring. Separately, another slurry may be formed by combining the binder material with a fluid such as water. The binder slurry may then be combined with the slurry containing the zeolites and matrix material to form an all-ingredients slurry. The all-ingredients slurry may be dried, for example by spraying, and then calcined to produce the microparticles of the cracking catalyst.

The first multicomponent catalysts 124 and the second multicomponent catalyst 144 may be contacted with steam prior to use in the system 100. The purpose of steam treatment is to accelerate the hydrothermal aging of the first multicomponent catalysts 124 and the second multicomponent catalyst 144 that occurs during operation of the system 100 to obtain an equilibrium catalyst. Steam treatment may lead to the removal of aluminum from the framework leading to a decrease in the number of sites where framework hydrolysis can occur under hydrothermal and thermal conditions. This removal of aluminum results in an increased thermal and hydrothermal stability in dealuminated zeolites. The unit cell size may decrease as a result of dealumination since the smaller SiO₄ tetrahedron replaces the larger AlO₄⁻ tetrahedron. The acidity of zeolites may also affected by dealumination through the removal of framework aluminum and the formation of extra-framework aluminum species. Dealumination may affect the acidity of the zeolite by decreasing the total acidity and increasing the acid strength of the zeolite. The total acidity may decrease because of the removal of framework aluminum, which act as Bronsted acid sites. The acid strength of the zeolite may be increased because of the removal of paired acid sites or the removal of the second coordinate next nearest neighbor aluminum. The increase in the acid strength may be caused by the charge density on the proton of the OH group being highest when there is no framework aluminum in the second coordination sphere.

### EXAMPLES

The various aspects of the present disclosure will be further clarified by the following examples. The examples are illustrative in nature and should not be understood to limit the subject matter of the present disclosure.

### Example 1

In Example 1, a multicomponent catalyst was prepared. First, a matrix slurry was prepared by mixing 243.54 grams of kaolin clay with 586.46 grams of deionized water. Separately, a zeolite slurry was prepared by mixing 240.96 grams of zeolite Beta (commercially available as CP814C from Zeolyst International) with 559.04 grams of deionized water. While stirring the first large pore molecular sieve slurry, 28.42 grams of ortho-phosphoric acid (H₃PO₄) was gradually added and the slurry was stirred for an additional 15 minutes. The matrix slurry and the zeolite slurry were then mixed together for at least 5 minutes.

Separately, a binder slurry was prepared by mixing 104.17 grams of binder (commercially available as CATAPAL® from Sasol Performance Chemicals) with 195.83 grams of deionized water. The binder was peptized by the addition of 5.25 grams of formic acid to the binder slurry. The peptized binder slurry was then added to the mixture of the matrix slurry and the zeolite slurry and stirred vigorously for 1 hour. The resulting mixture was sieved to remove any large solids and spray dried to produce multicomponent catalyst particles. The multicomponent catalyst particles were then calcined at 500° C. for three hours to produce the multicomponent catalysts. The multicomponent catalysts were then steam deactivated at 810° C. for 6 hours prior to further testing.

The composition of the multicomponent catalyst of Example 1 is reported in Table 2.

### Example 2

In Example 2, a multicomponent catalyst was prepared. First, a matrix slurry was prepared by mixing 190.14 grams of kaolin clay with 349.86 grams of deionized water. Separately, a zeolite slurry was prepared by mixing 45.45 grams of ZSM-5 (commercially available as SP13-0159 from W.R. Grace and Company), 96.39 grams of zeolite Beta (commercially available as CP814C from Zeolyst International), and 48.78 grams of USY zeolite (commercially available as CBV 2314 from Zeolyst International) with 342.71 grams of deionized water. While stirring the zeolite slurry, 22.73 grams of ortho-phosphoric acid (H₃PO₄) was gradually added and the slurry was stirred for an additional 15 minutes, after which 10.74 grams of lanthanum nitrate hexahydrate (La(NO₃)₃.6H₂O) was added and the slurry was stirred for another 15 minutes. The matrix slurry and the zeolite slurry were then mixed together for at least 5 minutes.

Separately, a binder slurry was prepared by mixing 83.33 grams of binder (commercially available as CATAPAL® from Sasol Performance Chemicals) with 116.67 grams of deionized water. The binder was peptized by the addition of 4.20 grams of formic acid to the binder slurry. The peptized binder slurry was then added to the mixture of the matrix slurry and the zeolite slurry and stirred vigorously for 1 hour. The resulting mixture was sieved to remove any large solids and spray dried to produce multicomponent catalyst particles. The multicomponent catalyst particles were then calcined at 500° C. for three hours to produce the multicomponent catalysts. The multicomponent catalysts were then steam deactivated at 810° C. for 6 hours prior to further testing.

The composition of the multicomponent catalyst of Example 2 is reported in Table 2.

### Example 3

In Example 3, a multicomponent catalyst was prepared. First, a matrix slurry was prepared by mixing 243.54 grams of kaolin clay with 586.46 grams of deionized water. Separately, a zeolite slurry was prepared by mixing 54.35 grams of ZSM-5 (commercially available as SP13-0159 from W.R. Grace and Company), 112.06 grams of zeolite Beta (commercially available as CP814C from Zeolyst International), and 60.98 grams of USY zeolite (commercially available as CBV 2314 from Zeolyst International) with 439.29 grams of deionized water. While stirring the zeolite slurry, ortho-phosphoric acid (H₃PO₄) was gradually added and the slurry was stirred for an additional 15 minutes. The matrix slurry and the zeolite slurry were then mixed together for at least 5 minutes.

Separately, a binder slurry was prepared by mixing 138.89 grams of binder (commercially available as CATAPAL® from Sasol Performance Chemicals) with 194.44 grams of deionized water. The binder was peptized by the addition of 7.00 grams of formic acid to the binder slurry. The peptized binder slurry was then added to the mixture of the matrix slurry and the zeolite slurry and stirred vigorously for 1 hour. The resulting mixture was sieved to remove any large solids and spray dried to produce multicomponent catalyst particles. The multicomponent catalyst particles were then calcined at 500° C. for three hours to produce the multicomponent catalysts. The multicomponent catalysts were then steam deactivated at 810° C. for 6 hours prior to further testing.

The composition of the multicomponent catalyst of Example 3 is reported in Table 2.

TABLE 2

| Multicomponent Catalyst | Example 1 | Example 2 | Example 3 |
|---|---|---|---|
| Matrix (wt. %) | 41.5 | 41.5 | 36.5 |
| Binder (wt. %) | 15 | 15 | 20 |
| Phosphorus Pentoxide (wt. %) | 3.5 | 3.5 | 3.5 |
| ZSM-5 (wt. %) | — | 10 | 10 |
| Zeolite Beta (wt. %) | 40 | 20 | 20 |
| USY Zeolite (wt. %) | — | 10 | 10 |

### Example 4

In Example 4, catalytic cracking of various fractions of Arab Extra Light (AXL) crude oil with the multicomponent catalysts of Example 1, Example 2, and Example 3, as well as a mixture including 75 wt. % of Equilibrium Catalyst (ECAT) and 25 wt. % of ZSM-5 (commercially available as OlefinsUltra® from W.R. Grace and Company) (referred to as “UMIX75”), was carried out in a microdowner reactor unit. A general description of the laboratory-scale micro downer FCC unit and operation of the unit may be found in Corma et al., A New Continuous Laboratory Reactor For the Study of Catalytic Cracking, Applied Catalysts A: General. 232(1):247-263 (June 2002), which is incorporated by reference in this disclosure in its entirety. For each run, a full mass balance was obtained and was found to be around 100 percent (%). All runs were performed at a cracking temperature of 600° C. The results of each run are reported in Tables 3-5.

TABLE 3

| Catalyst | UMIX75 | Example 1 | Example 2 | Example 3 |
|---|---|---|---|---|
| Feed | ≤350° C. | ≤350° C. | ≤350° C. | ≤350° C. |
| Catalyst to Oil Ratio | 30 | 30 | 23 | 29 |
| Conversion (%) | 57.60 | 54.79 | 44.28 | 45.05 |

Yield (wt. %)

| | | | | |
|---|---|---|---|---|
| H₂ | 0.15 | 0.16 | 0.13 | 0.22 |
| C₁ | 2.29 | 2.16 | 2.96 | 3.38 |
| C₂ | 2.02 | 1.49 | 1.99 | 2.39 |
| C₂═ | 8.89 | 6.12 | 5.51 | 6.60 |
| C₃ | 5.62 | 3.60 | 1.46 | 1.59 |
| C₃═ | 18.15 | 18.83 | 14.46 | 15.67 |
| iC₄ | 6.02 | 5.20 | 2.24 | 1.24 |
| nC₄ | 2.95 | 2.83 | 1.29 | 0.98 |
| C₄═ | 10.50 | 13.27 | 11.05 | 11.52 |
| Coke | 1.00 | 1.12 | 3.20 | 1.44 |

Groups (wt. %)

| | | | | |
|---|---|---|---|---|
| Fuel Gas (H₂ + C₁ + C₂) | 4.46 | 3.82 | 5.08 | 5.99 |
| C₃-C₄ (LPG) | 43.25 | 43.73 | 30.50 | 31.01 |
| C₂═−C₄═ (Light Olefins) | 37.55 | 38.22 | 31.02 | 33.80 |
| Total Gas | 56.60 | 53.67 | 41.08 | 43.61 |
| Gasoline | 42.40 | 45.22 | 55.72 | 54.95 |

TABLE 4

| Catalyst | UMIX75 | Example 1 | Example 2 | Example 3 |
|---|---|---|---|---|
| Feed | ≥350° C. | ≥350° C. | ≥350° C. | ≥350° C. |
| Catalyst to Oil Ratio | 25 | 25 | 32 | 25 |
| Conversion (%) | 61.16 | 54.14 | 65.72 | 54.22 |

Yield (wt. %)

| | | | | |
|---|---|---|---|---|
| H₂ | 0.17 | 0.29 | 0.40 | 0.19 |
| C₁ | 2.16 | 4.06 | 4.83 | 3.53 |
| C₂ | 2.38 | 2.26 | 2.64 | 2.51 |
| C₂═ | 8.62 | 6.07 | 8.05 | 6.04 |
| C₃ | 9.88 | 2.21 | 2.52 | 2.26 |
| C₃═ | 15.66 | 18.29 | 21.12 | 18.49 |
| iC₄ | 5.81 | 1.68 | 1.64 | 1.55 |
| nC₄ | 4.13 | 0.59 | 0.61 | 0.80 |
| C₄═ | 10.11 | 13.58 | 15.86 | 14.36 |
| Coke | 2.22 | 5.11 | 8.05 | 4.49 |

Groups (wt. %)

| | | | | |
|---|---|---|---|---|
| Fuel Gas (H₂ + C₁ + C₂) | 4.72 | 6.61 | 7.87 | 6.23 |
| C₃-C₄ (LPG) | 45.60 | 36.55 | 41.74 | 37.46 |
| C₂═-C4═ (Light Olefins) | 34.40 | 37.94 | 45.03 | 38.89 |
| Total Gas | 58.94 | 49.03 | 57.67 | 49.73 |
| Gasoline | 38.84 | 45.86 | 27.95 | 45.78 |

TABLE 5

| Catalyst | UMIX75 | Example 1 | Example 2 | Example 3 |
|---|---|---|---|---|
| Feed | Whole Crude | Whole Crude | Whole Crude | Whole Crude |
| Catalyst to Oil Ratio | 25 | 21 | 21 | 25 |
| Conversion (%) | 61.16 | 54.83 | 51.29 | 49.69 |

Yield (wt. %)

| | | | | |
|---|---|---|---|---|
| H₂ | 0.17 | 0.09 | 0.33 | 0.20 |
| C₁ | 2.16 | 2.21 | 4.44 | 2.95 |
| C₂ | 2.38 | 1.73 | 2.71 | 2.04 |
| C₂═ | 8.62 | 5.83 | 7.11 | 4.63 |
| C₃ | 9.88 | 3.13 | 1.81 | 2.20 |
| C₃═ | 15.66 | 17.99 | 14.38 | 16.35 |
| iC₄ | 5.81 | 5.43 | 0.97 | 2.45 |
| nC₄ | 4.13 | 2.35 | 1.45 | 0.87 |
| C₄═ | 10.11 | 13.07 | 8.21 | 13.75 |
| Coke | 2.22 | 3.00 | 10.32 | 4.20 |

Groups (wt. %)

| | | | | |
|---|---|---|---|---|
| Fuel Gas (H₂ + C₁ + C₂) | 4.72 | 4.03 | 4.76 | 5.19 |
| C₃-C₄ (LPG) | 45.60 | 41.97 | 26.40 | 35.62 |
| C₂═-C₄═ (Light Olefins) | 34.40 | 36.89 | 29.70 | 34.74 |
| Total Gas | 58.94 | 51.83 | 40.98 | 45.42 |
| Gasoline | 38.84 | 45.17 | 30.73 | 50.38 |

As indicated by Tables 3-5, the multicomponent catalysts of the present application result in a greater selectivity and yield of light olefins across a greater range of crude oil. For example, while UMIX75 resulted in a greater (that is, 3.75 wt. % greater) yield of light olefins than the multicomponent catalyst of Example 3 when the hydrocarbon feed boils at a temperature less than 350° C., the multicomponent catalyst of Example 3 resulted in an even greater (that is, 4.49 wt. % greater) yield of light olefins than UMIX75. As such, when used to upgrade a hydrocarbon feed that has been first separated into a greater boiling point effluent and a lesser boiling point effluent, such as in the embodiments of the present application, Tables 3-5 indicate that the multicomponent catalyst of Example 3 will result in a greater yield of light olefins. Similarly, Tables 3-5 indicate that the multicomponent catalyst of Example 1 will result in a greater yield of olefin for both the greater and lesser boiling point effluents and the multicomponent catalyst of Example 2 will result in a yield of olefin that is significantly greater when upgrading the greater boiling point effluent.

According to a first aspect of the present disclosure, a method for upgrading a hydrocarbon feed may include introducing the hydrocarbon feed to a separation unit, where the separation unit may separate the hydrocarbon feed to produce at least a greater boiling point effluent and a lesser boiling point effluent, and the greater boiling point effluent may have an American Petroleum Institute gravity less than 30 degrees. The method may further include passing the greater boiling point effluent to a first downflow fluid catalytic cracking unit downstream of the separation unit, where the first downflow fluid catalytic cracking unit may contact the greater boiling point effluent with a multicomponent catalyst. The contact may cause at least a portion of the greater boiling point effluent to undergo catalytic cracking and produce a first spent multicomponent catalyst and a first cracked effluent comprising one or more olefins. The multicomponent catalyst may comprise from 0 weight percent to 10 weight percent ZSM-5, from 10 weight percent to 40 weight percent zeolite Beta, and from 10 weight percent to 30 weight percent USY zeolite based on the total weight of the multicomponent catalyst.

A second aspect of the present disclosure may include the first aspect, further including passing the first spent multicomponent catalyst to a regenerator that may regenerate at least a portion of the first spent multicomponent catalyst to produce a regenerated multicomponent catalyst; and passing at least a portion of the regenerated multicomponent catalyst to the first downflow fluid catalytic cracking unit such that the multicomponent catalyst may comprise the at least a portion of the regenerated multicomponent catalyst.

A third aspect of the present disclosure may include either one of the first or second aspect, further including passing the lesser boiling point effluent to a second downflow fluid catalytic cracking unit downstream of the separation unit and parallel to the first downflow fluid catalytic cracking unit. The second downflow fluid catalytic cracking unit may contact the lesser boiling point effluent with the multicomponent catalyst, the contact causing at least a portion of the lesser boiling point effluent to undergo catalytic cracking to produce a second spent multicomponent catalyst and a second cracked effluent comprising one or more olefins.

A fourth aspect of the present disclosure may include the third aspect, further including passing the second spent multicomponent catalyst to a regenerator that may regenerate at least a portion of the second spent multicomponent catalyst to produce a regenerated multicomponent catalyst, and passing at least a portion of the regenerated multicomponent catalyst to the second downflow fluid catalytic cracking unit such that the multicomponent catalyst may comprise the at least a portion of the regenerated multicomponent catalyst.

According to a fifth aspect of the present disclosure, a method for upgrading a hydrocarbon feed may include separating the hydrocarbon feed to produce at least a greater boiling point effluent and a lesser boiling point effluent, where the greater boiling point effluent may have an American Petroleum Institute gravity less than 30 degrees; and contacting the greater boiling point effluent with a multicomponent catalyst. The contacting may cause at least a portion of the greater boiling point effluent to undergo catalytic cracking and produce a first spent multicomponent catalyst and a first cracked effluent comprising one or more olefins. The multicomponent catalyst may comprise from 0 weight percent to 10 weight percent ZSM-5, from 10 weight percent to 40 weight percent zeolite Beta, and from 10 weight percent to 30 weight percent USY zeolite based on the total weight of the multicomponent catalyst.

A sixth aspect of the present disclosure may include the fifth aspect, where separating the hydrocarbon feed may comprise introducing the hydrocarbon feed to a separation unit that separates the hydrocarbon feed.

A seventh aspect of the present disclosure may include either one of the fifth or sixth aspect, where contacting the greater boiling point effluent with the multicomponent catalyst may comprise passing the greater boiling point effluent to a first downflow fluid catalytic cracking unit that may contact the greater boiling point effluent with a multicomponent catalyst.

An eighth aspect of the present disclosure may include any one of the fifth through seventh aspects, further including regenerating at least a portion of the first spent multicomponent catalyst to produce a regenerated multicomponent catalyst, and recycling at least a portion of the regenerated multicomponent catalyst into contact with the greater boiling point effluent such that the multicomponent catalyst may comprise at least a portion of the regenerated multicomponent catalyst.

A ninth aspect of the present disclosure may include the eighth aspect, where regenerating at least a portion of the first spent multicomponent catalyst may comprise passing the first spent multicomponent catalyst to a regenerator that may regenerate at least a portion of the spent multicomponent catalyst.

A tenth aspect of the present disclosure may include any one of the fifth through ninth aspects, further including contacting the lesser boiling point effluent with the multicomponent catalyst. The contacting may cause at least a portion of the lesser boiling point effluent to undergo catalytic cracking and produce a second spent multicomponent catalyst and a second cracked effluent comprising one or more olefins.

An eleventh aspect of the present disclosure may include the tenth aspect, where contacting the lesser boiling point effluent with the multicomponent catalyst may comprise passing the lesser boiling point effluent to a second downflow fluid catalytic cracking unit that may contact the lesser boiling point effluent with a multicomponent catalyst.

A twelfth aspect of the present disclosure may include either one of the tenth or eleventh aspect, further including regenerating at least a portion of the second spent multicomponent catalyst to produce a regenerated multicomponent catalyst, and recycling at least a portion of the regenerated multicomponent catalyst such that the multicomponent catalyst may comprise at least a portion of the regenerated multicomponent catalyst.

A thirteenth aspect of the present disclosure may include the twelfth aspect, where regenerating at least a portion of the second spent multicomponent catalyst may comprise passing the second spent multicomponent catalyst to a regenerator that may regenerate at least a portion of the spent multicomponent catalyst.

A fourteenth aspect of the present disclosure may include any one of the first through thirteenth aspects, where the greater boiling point effluent may comprise hydrocarbons boiling at temperatures greater than or equal to 350 degrees Celsius.

A fifteenth aspect of the present disclosure may include any one of the first through fourteenth aspects, where the lesser boiling point effluent may comprise hydrocarbons boiling at temperatures less than 350 degrees Celsius.

A sixteenth aspect of the present disclosure may include any one of the first through fifteenth aspects, where the hydrocarbon feed may be a crude oil.

A seventeenth aspect of the present disclosure may include any one of the first through sixteenth aspects, where the ZSM-5, the zeolite Beta, and the USY zeolite each may comprise from 1 weight percent to 20 weight percent phosphorous pentoxide based on the total weight of each of the ZSM-5, the zeolite Beta, and the USY zeolite, respectively.

An eighteenth aspect of the present disclosure may include any one of the first through seventeenth aspects, where the ZSM-5, the zeolite Beta, and the USY zeolite each may comprise from 1 weight percent to 5 weight percent rare earth metal based on the total weight of each of the ZSM-5, the zeolite Beta, and the USY zeolite, respectively.

A nineteenth aspect of the present disclosure may include any one of the first through eighteenth aspects, where the multicomponent catalyst may further comprises from 10 weight percent to 30 weight percent binder materials and from 30 weight percent to 60 weight percent matrix materials based on the total weight of the multicomponent catalyst.

A twentieth aspect of the present disclosure may include any one of the first through nineteenth aspects, where the first downflow fluid catalytic cracking unit is operated under high-severity conditions.

A twenty-first aspect of the present disclosure may include the twentieth aspect, where the first downflow fluid catalytic cracking unit contacts the greater boiling point effluent with the multicomponent catalyst at a temperature of from 580 degrees Celsius to 750 degrees Celsius.

A twenty-second aspect of the present disclosure may include either one of the twentieth or twenty-first aspect, where the residence time of the greater boiling point effluent in the first downflow fluid catalytic cracking unit is from 0.1 seconds to 60 seconds.

A twenty-third aspect of the present disclosure may include any one of the first through twenty-second aspects, where the second downflow fluid catalytic cracking unit is operated under high-severity conditions.

A twenty-fourth aspect of the present disclosure may include the twenty-third aspect, where the second downflow fluid catalytic cracking unit contacts the lesser boiling point effluent with the multicomponent catalyst at a temperature of from 580 degrees Celsius to 750 degrees Celsius.

A twenty-fifth aspect of the present disclosure may include either one of the twenty-third or twenty-fourth aspect, where the second downflow fluid catalytic cracking unit contacts the lesser boiling point effluent with the multicomponent catalyst at a temperature greater than the temperature the first downflow fluid catalytic cracking unit contacts the greater boiling point effluent with the multicomponent catalyst.

A twenty-sixth aspect of the present disclosure may include any one of the twenty-third through twenty-fifth aspects, where the residence time of the lesser boiling point effluent in the second downflow fluid catalytic cracking unit is from 0.1 seconds to 60 seconds.

It is noted that any two quantitative values assigned to a property may constitute a range of that property, and all combinations of ranges formed from all stated quantitative values of a given property are contemplated in this disclosure.

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific aspects, it is noted that the various details of such aspects should not be taken to imply that these details are essential components of the aspects. Rather, the claims appended hereto should be taken as the sole representation of the breadth of the present disclosure and the corresponding scope of the various aspects described in this disclosure. Further, it will be apparent that modifications and variations are possible without departing from the scope of the appended claims.

1. A method for upgrading a hydrocarbon feed, the method comprising:
introducing the hydrocarbon feed to a separation unit, where the separation unit separates the hydrocarbon feed to produce at least a greater boiling point effluent and a lesser boiling point effluent, and the greater boiling point effluent has an American Petroleum Institute gravity less than 30 degrees; and
passing the greater boiling point effluent to a first downflow fluid catalytic cracking unit downstream of the separation unit, where the first downflow fluid catalytic cracking unit contacts the greater boiling point effluent with a multicomponent catalyst, the contact causing at least a portion of the greater boiling point effluent to undergo catalytic cracking and produce a first spent multicomponent catalyst and a first cracked effluent comprising one or more olefins;
where the multicomponent catalyst comprises from 0 weight percent to 10 weight percent ZSM-5, from 10 weight percent to 40 weight percent zeolite Beta, and from 10 weight percent to 30 weight percent USY zeolite based on the total weight of the multicomponent catalyst, and where one or more transition metals are substituted into the framework of the USY zeolite.

2. The method of claim 1, where the greater boiling point effluent comprises hydrocarbons boiling at temperatures greater than 350 degrees Celsius and where the lesser boiling point effluent comprises hydrocarbons boiling at temperatures less than 350 degrees Celsius.

3. (canceled)

4. The method of claim 1, where the hydrocarbon feed is a crude oil.

5. The method of claim 1, further comprising:
passing the first spent multicomponent catalyst to a regenerator that regenerates at least a portion of the first spent multicomponent catalyst to produce a regenerated multicomponent catalyst; and
passing at least a portion of the regenerated multicomponent catalyst to the first downflow fluid catalytic cracking unit such that the multicomponent catalyst comprises the at least a portion of the regenerated multicomponent catalyst.

6. The method of claim 1, further comprising passing the lesser boiling point effluent to a second downflow fluid catalytic cracking unit downstream of the separation unit and parallel to the first downflow fluid catalytic cracking unit, where the second downflow fluid catalytic cracking unit contacts the lesser boiling point effluent with the multicomponent catalyst, the contact causing at least a portion of the lesser boiling point effluent to undergo catalytic cracking to produce a second spent multicomponent catalyst and a second cracked effluent comprising one or more olefins.

7. The method of claim 6, further comprising:
passing the second spent multicomponent catalyst to a regenerator that regenerates at least a portion of the second spent multicomponent catalyst to produce a regenerated multicomponent catalyst; and
passing at least a portion of the regenerated multicomponent catalyst to the second downflow fluid catalytic cracking unit such that the multicomponent catalyst comprises the at least a portion of the regenerated multicomponent catalyst.

8. The method of claim 1, where the ZSM-5, the zeolite Beta, and the USY zeolite each comprise from 1 weight percent to 20 weight percent phosphorous pentoxide based on the total weight of each of the ZSM-5, the zeolite Beta, and the USY zeolite.

9. The method of claim 1, where the ZSM-5, the zeolite Beta, and the USY zeolite each comprise from 1 weight percent to 5 weight percent rare earth metal based on the total weight of each of the ZSM-5, the zeolite Beta, and the USY zeolite.

10. The method of claim 1, where the multicomponent catalyst further comprises from 10 weight percent to 30 weight percent binder materials and from 30 weight percent to 60 weight percent matrix materials based on the total weight of the multicomponent catalyst.

11. A method for upgrading a hydrocarbon feed, the method comprising:
separating the hydrocarbon feed to produce at least a greater boiling point effluent and a lesser boiling point effluent, where the greater boiling point effluent has an American Petroleum Institute gravity less than 30 degrees; and
contacting the greater boiling point effluent with a multicomponent catalyst, the contacting causing at least a portion of the greater boiling point effluent to undergo catalytic cracking and produce a first spent multicomponent catalyst and a first cracked effluent comprising one or more olefins,
where the multicomponent catalyst comprises from 0 weight percent to 10 weight percent ZSM-5, from 10 weight percent to 40 weight percent zeolite Beta, and from 10 weight percent to 30 weight percent USY zeolite based on the total weight of the multicomponent catalyst, and where one or more transition metals are substituted into the framework of the USY zeolite.

12. The method of claim 11, where the greater boiling point effluent comprises hydrocarbons boiling at temperatures greater than 350 degrees Celsius and where the lesser boiling point effluent comprises hydrocarbons boiling at temperatures less than 350 degrees Celsius.

13. (canceled)

14. The method of claim 11, where the hydrocarbon feed is a crude oil.

15. The method of claim 11, where separating the hydrocarbon feed comprises introducing the hydrocarbon feed to a introducing the hydrocarbon feed to a separation unit that separates the hydrocarbon feed.

16. The method of claim 11, where contacting the greater boiling point effluent with the multicomponent catalyst comprises passing the greater boiling point effluent to a first downflow fluid catalytic cracking unit that contacts the greater boiling point effluent with a multicomponent catalyst.

17. The method of claim 11, further comprising:
regenerating at least a portion of the first spent multicomponent catalyst to produce a regenerated multicomponent catalyst;
where regenerating at least a portion of the first spent multicomponent catalyst comprises passing the first spent multicomponent catalyst to a regenerator that regenerates at least a portion of the spent multicomponent catalyst; and
recycling at least a portion of the regenerated multicomponent catalyst into contact with the greater boiling point effluent such that the multicomponent catalyst comprises at least a portion of the regenerated multicomponent catalyst.

18. (canceled)

19. The method of claim 11, further comprising contacting the lesser boiling point effluent with the multicomponent catalyst, the contacting causing at least a portion of the lesser boiling point effluent to undergo catalytic cracking and produce a second spent multicomponent catalyst and a second cracked effluent comprising one or more olefins.

20. The method of claim 19, where contacting the lesser boiling point effluent with the multicomponent catalyst comprises passing the lesser boiling point effluent to a second downflow fluid catalytic cracking unit that contacts the lesser boiling point effluent with a multicomponent catalyst.

21. The method of claim 6 where:
the first downflow fluid catalytic cracking unit comprises a first multicomponent catalyst;
the second downflow catalytic cracking unit comprises a second multicomponent catalyst; and
the second multicomponent catalyst comprises one or more components that are different from the first multicomponent catalyst.

22. The method of claim 6 where:
the first downflow fluid catalytic cracking unit comprises a first multicomponent catalyst;
the second downflow catalytic cracking unit comprises a second multicomponent catalyst; and
the second multicomponent catalyst comprises the same components in amounts different from the first multicomponent catalyst.

23. The method of claim 1 where the catalyst comprises 10 weight percent ZSM-5, 20 weight percent zeolite Beta, and 10 weight percent USY zeolite based on the total weight of the multicomponent catalyst.
